(19) United States
(12) Patent Application Publication
(10) Pub. No.: US 2025/0018356 A1
(43) Pub. Date: Jan. 16, 2025

(54) SYSTEMS AND METHODS FOR THERMAL STORAGE INTEGRATION INTO HIGH TEMPERATURE DECOMPOSITION REACTOR

(71) Applicant: Heirloom Carbon Technologies, Inc., Brisbane, CA (US)

(72) Inventors: Noah MCQUEEN, San Francisco, CA (US); Shashank SAMALA, San Francisco, CA (US); Andrew DUBEL, Moss Beach, CA (US)

(21) Appl. No.: 18/771,456

(22) Filed: Jul. 12, 2024

Related U.S. Application Data
(60) Provisional application No. 63/513,706, filed on Jul. 14, 2023.

(51) Int. Cl. B01J 19/00

(52) U.S. Cl. CPC B01J 19/0053; B01J 2219/00155; B01J 2219/02

(57) ABSTRACT

A high-temperature decomposition reactor is provided. The reactor includes a reaction vessel, a furnace, and an insulation layer. The reaction vessel includes an inner volume configured to contain a quantity of carbonated medium while the quantity of carbonated medium transitions to a quantity of carbonation medium. The furnace is disposed around the reaction vessel and includes a furnace material. The furnace material is configured to simultaneously absorb heat and transmit heat. In some instances, the furnace material transmits heat to the inner volume to heat the carbonated medium. The insulation layer is disposed around the furnace and configured to prevent thermal losses from the reactor.

### CROSS-REFERENCE TO RELATED APPLICATIONS

This application claims the benefit of U.S. Provisional Application No. 63/513,706, entitled “Systems and Methods for Thermal Storage Integration into High-Temperature Decomposition Reactor,” filed Jul. 14, 2023, the disclosure of which is incorporated herein by reference.

### TECHNICAL FIELD

Embodiments described herein relate to extraction and sequestration of carbon dioxide from ambient air.

### BACKGROUND

The atmospheric concentration of carbon dioxide (CO₂) has reached 420 parts per million by volume (ppm), an increase of almost 20 ppm in the last 10 years. As current emission levels exceed 35 billion tonnes of C02 per year (GtCO₂/year), a diverse portfolio of CO₂ mitigation technologies must be developed and strategically deployed to avoid a 2° C. increase in Earth's average surface temperature by the year 2100. Due to global reliance on fossil fuels, this portfolio must include technologies that can remove current and future CO₂ emissions from the atmosphere, some of which include the acceleration of natural processes such as the CO₂ uptake of oceans and the terrestrial biosphere (soils, forests, minerals), bioenergy with carbon capture and storage (BECCS), and synthetic approaches using chemicals also known as direct air capture with storage (DACS) technologies. State of the art DACS systems rely on media to capture CO₂ from the atmosphere.

High temperature reactors can be used to separate CO₂ from media used to capture the CO₂. High temperature reactors often require continuous operation to avoid extensive startup and shutdown periods, as well as to utilize the capital investment. However, the availability of renewable energy sources is typically intermittent—limited to times when the sun is shining and/or wind is blowing. Thus, a need exists for a means of energy storage in high temperature reactors.

### SUMMARY

Embodiments described herein relate to thermal energy storage in high temperature reactors (e.g., calciners). In some aspects, a reactor can include a reaction vessel that includes an inner volume the contains a quantity of carbonated medium while the quantity of carbonated medium transitions to a quantity of carbonation medium. The reactor can further include a furnace disposed around the reaction vessel. The furnace includes a furnace material that simultaneously absorbs and transmits heat. The reactor further includes an insulation layer disposed around the furnace. The insulation layer can prevent thermal losses from the reactor. In some embodiments, the reaction vessel can be composed of a conductive metal. In some embodiments, the reaction vessel can be composed of a thermal storage material. In some embodiments, the furnace can include graphite, granite, basalt, and/or quartzite. In some embodiments, the reactor can include a crevice, into which molten salt circulates to provide heat to the reaction vessel.

### BRIEF DESCRIPTION OF THE DRAWINGS

FIG. 1 is a block diagram of a high-temperature decomposition reactor, according to an embodiment.

FIG. 2 is an illustration of a high-temperature decomposition reactor, according to an embodiment.

FIG. 3 is a perspective view of a portion of the high-temperature decomposition reactor of FIG. 2.

FIG. 4 is a perspective view of a portion of a high-temperature decomposition reactor, according to an embodiment.

FIG. 5 is a flow diagram of a method of operating the high-temperature decomposition reactor of any of FIGS. 1-4.

### DETAILED DESCRIPTION

Integrating thermal energy storage into a high-temperature reactor can enable the use of stored energy during hours when renewable energy is normally not available, abundant, or cheap. Such thermal integration can also enable use of such resources when they are not available (e.g., using stored solar energy at night, using stored wind energy during calm weather). Integrated energy storage can ease the issues caused by the intermittency of renewable energy sources and can reduce the cost of energy, as energy surpluses can be stored during the day when such resources are available. This can also act as a means to store excess energy from the grid for use.

Materials that store thermal energy (e.g., graphite) can also allow the use of multiple electricity inputs as a source of energy. For example, a first electricity input can be fed from an onsite renewable energy source (e.g., solar, wind) and a second electricity input can be fed from the electric grid. The second electricity input can allow for a backup source of energy when there are prolonged periods of time, in which renewable energy is not directly available (e.g., times when the wind is not blowing and/or the sun is not shining).

In the current state of the art, thermal storage systems are in development for various applications, including building temperature control, point source carbon capture, and renewable energy storage. These systems often include a single block of solid material. In some cases, such systems can include liquids and/or gases. These blocks are used to consistently provide heat to the system.

Embodiments described herein include the integration of a thermal storage system and a calcining reactor into a single piece of equipment that can increase the thermal efficiency of the system and prevent energy losses associated with transport from the storage entity to the reaction system itself. Several other approaches include individual charging and discharging of the system's energy. Embodiments described herein include simultaneous charging and discharging of a thermal storage system.

In some embodiments, calciners or other processing equipment described herein can be the same or substantially similar to equipment described in U.S. patent application Ser. No. 18/067,896 (“the '896 application”), filed Dec. 19, 2022, and titled “Systems and Methods of Carbon Capture from Cement Production Process,” the disclosure of which is hereby incorporated by reference in its entirety. In some embodiments, carbonation media or carbonated media described herein can be the same or similar to those described in the '896 application. In some embodiments, carbonation media or carbonated media described herein can include water, or can be processed with water to improve uptake, as described in International Patent Publication No. US2022/018484 (“the '484 publication”), filed Mar. 2, 2022, and titled, “Systems and Methods for Enhanced Weathering in and Calcining for CO₂ Removal from Air,” the disclosure of which is hereby incorporated by reference in its entirety.

As used herein, “carbonation plot,” includes single contiguous plots, as well as semi- or non-contiguous plots that are then grouped or processed together to effectively act as a single plot. In some embodiments, carbonation plots include a composition that sequesters a target compound (e.g., CO₂). In some embodiments, carbonation plots are positioned and configured to expose the composition to ambient conditions.

As used herein, “stream” can refer to stream that includes solid, liquid, and/or gas. For example, a stream can include a solid in granular form conveyed on a conveyor device. A stream can also include a liquid and/or gas flowing through a pipe. A stream can include a solution.

As used herein, “carbonation medium” refers to a medium that can take on carbon dioxide when exposed to ambient air. This can include but is not limited to calcium oxide (CaO), calcium hydroxide (Ca(OH)₂), magnesium oxide (MgO), magnesium hydroxide (MgOH), sodium oxide (Na₂O), sodium hydroxide (NaOH), and/or dolomitic lime (calcium-magnesium oxide or hydroxide). Carbonation medium can originate from a natural source (e.g., limestone). Carbonation medium can also be regenerated or recycled (i.e., a regenerated carbonated medium from a calciner).

As used herein, “carbonated medium” refers to a carbonation medium that has taken up carbon dioxide from ambient air. This can include but is not limited to calcium carbonate (CaCO₃), magnesium carbonate (MgCO₃), sodium carbonate (Na₂CO₃), sodium bicarbonate (NaHCO₃), mixed calcium-magnesium carbonate phases ((Ca,Mg)CO₃). Carbonated medium can be converted back to a carbonation medium (e.g., via the use of a calciner, a dissolution/precipitation-based system, and/or an electrochemical system).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

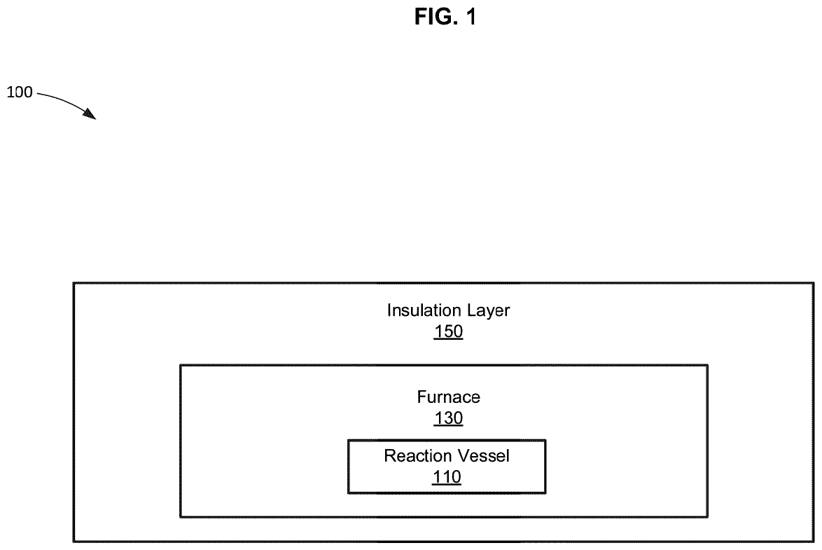

FIG. 1 is a block diagram of a high-temperature decomposition reactor 100 (hereinafter “reactor 100”), according to an embodiment. As shown, the reactor 100 includes a reaction vessel 110, a furnace 130, and an insulation layer 150. In some embodiments, the reactor 100 is used for calcination of species used for carbon capture.

The reaction vessel 110 includes an inner volume (not shown), in which heat permeates (e.g., to facilitate calcination). In some embodiments, the heat that permeates into the reaction vessel 110 can be a direct product solar energy. In other words, the sun can shine onto the furnace 130 and heat the furnace 130, and the heat in the furnace 130 can radiate into the reaction vessel 110. In some embodiments, the heat that permeates into the reaction vessel 110 can be a product of energy collected on solar cells and/or solar panels. In some embodiments, the heat that permeates into the reaction vessel 110 can be provided via electricity. In some embodiments, the heat that permeates into the reaction vessel 110 can be a product of wind energy (e.g., electricity from wind energy). In some embodiments, the heat that permeates into the reaction vessel 110 can be provided by electricity. In some embodiments, the heat that permeates into the reaction vessel 110 can be provided by combustion.

In some embodiments, the reaction vessel 110 can be composed of a metal. In some embodiments, the reaction vessel 110 can be composed of a conductive metal. In some embodiments, the reaction vessel 110 can be composed of stainless steel, 304 stainless steel, 316 stainless steel, aluminum, iron, wrought iron, cast iron, brass, tin, copper, antimony, or any combination thereof. In some embodiments, the reaction vessel 110 can be composed of an alloy. In some embodiments, the reaction vessel 110 can be composed of a copper-containing alloy. In some embodiments, the reaction vessel 110 can be composed of an aluminum-containing alloy. In some embodiments, the reaction vessel 110 can be formed via extrusion. In some embodiments, the reaction vessel 110 can be formed via welding of a metal sheet. In some embodiments, the reaction vessel 110 can be formed via electric resistance welding (ERW) of a metal sheet. In some embodiments, the reaction vessel 110 can be formed via acetylene torch welding of a metal sheet.

In some embodiments, during operation, the volume in the reaction vessel 110 can have a temperature of at least about 400° C., at least about 450° C., at least about 500° C., at least about 550° C., at least about 600° C., at least about 650° C., at least about 700° C., at least about 750° C., at least about 800° C., at least about 850° C., at least about 900° C., at least about 950° C., at least about 1,000° C., at least about 1,050° C., at least about 1,100° C., at least about 1,150° C., at least about 1,200° C., at least about 1,250° C., at least about 1,300° C., at least about 1,350° C., at least about 1,400° C., or at least about 1,450° C. In some embodiments, during operation, the volume in the reaction vessel 110 can have a temperature of no more than about 1,500° C., no more than about 1,450° C., no more than about 1,400° C., no more than about 1,350° C., no more than about 1,300° C., no more than about 1,250° C., no more than about 1,200° C., no more than about 1,150° C., no more than about 1,100° C., no more than about 1,050° C., no more than about 1,000° C., no more than about 950° C., no more than about 900° C., no more than about 850° C., no more than about 800° C., no more than about 750° C., no more than about 700° C., no more than about 650° C., no more than about 600° C., no more than about 550° C., no more than about 500° C., or no more than about 450° C. Combinations of the above-referenced temperatures are also possible (e.g., at least about 400° C. and no more than about 1,500° C. or at least about 750° C. and no more than about 1,200° C.) inclusive of all values and ranges therebetween. In some embodiments, during operation, the volume within the reaction vessel 110 can have a temperature of about 400° C., about 450° C., about 500° C., about 550° C., about 600° C., about 650° C., about 700° C., about 750° C., about 800° C., about 850° C., about 900° C., about 950° C., about 1,000° C., about 1,050° C., about 1,100° C., about 1,150° C., about 1,200° C., about 1,250° C., about 1,300° C., about 1,350° C., about 1,400° C., about 1,450° C., or about 1,500° C.

In some embodiments, the inner volume of the reaction vessel 110 can have a volume of at least about 10 L, at least about 20 L, at least about 30 L, at least about 40 L, at least about 50 L, at least about 60 L, at least about 70 L, at least about 80 L, at least about 90 L, at least about 100 L, at least about 200 L, at least about 300 L, at least about 400 L, at least about 500 L, at least about 600 L, at least about 700 L, at least about 800 L, at least about 900 L, at least about 1 m³, at least about 2 m³, at least about 3 m³, at least about 4 m³, at least about 5 m³, at least about 6 m³, at least about 7 m³, at least about 8 m³, at least about 9 m³, at least about 10 m³, at least about 20 m³, at least about 30 m³, at least about 40 m³, at least about 50 m³, at least about 60 m³, at least about 70 m³, at least about 80 m³, at least about 90 m³, at least about 100 m³, at least about 200 m³, at least about 300 m³, at least about 400 m³, at least about 500 m³, at least about 600 m³, at least about 700 m³, at least about 800 m³, at least about 900 m³. In some embodiments, the space inside the reaction vessel 110 can have a volume of no more than about 1,000 m³, no more than about 900 m³, no more than about 800 m³, no more than about 700 m³, no more than about 600 m³, no more than about 500 m³, no more than about 400 m³, no more than about 300 m³, no more than about 200 m³, no more than about 100 m³, no more than about 90 m³, no more than about 80 m³, no more than about 70 m³, no more than about 60 m³, no more than about 50 m³, no more than about 40 m³, no more than about 30 m³, no more than about 20 m³, no more than about 10 m³, no more than about 9 m³, no more than about 8 m³, no more than about 7 m³, no more than about 6 m³, no more than about 5 m³, no more than about 4 m³, no more than about 3 m³, no more than about 2 m³, no more than about 1 m³, no more than about 900 L, no more than about 800 L, no more than about 700 L, no more than about 600 L, no more than about 500 L, no more than about 400 L, no more than about 300 L, no more than about 200 L, no more than about 100 L, no more than about 90 L, no more than about 80 L, no more than about 70 L, no more than about 60 L, no more than about 50 L, no more than about 40 L, no more than about 30 L, or no more than about 20 L. Combinations of the above-referenced volumes are also possible (e.g., at least about 10 L and no more than about 1,000 m³ or at least about 50 L and no more than about 1 m³), inclusive of all values and ranges therebetween. In some embodiments, the space inside the reaction vessel 110 can have a volume of about 10 L, about 20 L, about 30 L, about 40 L, about 50 L, about 60 L, about 70 L, about 80 L, about 90 L, about 100 L, about 200 L, about 300 L, about 400 L, about 500 L, about 600 L, about 700 L, about 800 L, about 900 L, about 1 m³, about 2 m³, about 3 m³, about 4 m³, about 5 m³, about 6 m³, about 7 m³, about 8 m³, about 9 m³, about 10 m³, about 20 m³, about 30 m³, about 40 m³, about 50 m³, about 60 m³, about 70 m³, about 80 m³, about 90 m³, about 100 m³, about 200 m³, about 300 m³, about 400 m³, about 500 m³, about 600 m³, about 700 m³, about 800 m³, about 900 m³, or about 1,000 m³.

The furnace 130 is disposed around the outside of the reaction vessel 110 and is composed of a material (e.g., furnace material) capable of storing energy (e.g., renewable energy) and dispensing (e.g., discharging) the renewable energy into the reaction vessel 110 as heat. In some embodiments, the furnace 130 is symmetrically disposed around the reaction vessel 110 such that an equal or substantially equal thickness of the furnace 130 is disposed around the reaction vessel 110. In some embodiments, the furnace 130 is asymmetrically disposed around the reaction vessel 110 such that a greater thickness of the furnace 130 is disposed around some portions of the reaction vessel 130 than other portions. In some embodiments, the furnace 130 has a cylindrical shape or a substantially cylindrical shape. In some embodiments, the furnace 130 can have a rectangular pyramidal shape. In some embodiments, the furnace 130 can be composed of a solid thermal storage material. In some embodiments, the furnace 130 can include graphite. Graphite can simultaneously store energy and dispense the energy in the form of heat to the reaction vessel 110. In some embodiments, the furnace 130 can include granite, basalt, quartzite, travertine, sandstone, marble, slate, quartz, onyx, bluestone, laterite, dolomite, alabaster, amethyst, soapstone, metamorphic rock, gneiss, igneous rock, sedimentary rock, flint, jasper, rose quartz, or any other forms of stone or combinations thereof. In some embodiments, the furnace 130 can include a chamber, through which molten salt flows. The molten salt can provide heat to the reaction vessel. In some embodiments, the furnace 130 can be composed of sodium nitrate, lithium nitrate, potassium nitrate, sodium chloride, N-ethylpyridinium bromide mixtures if sodium nitrate and potassium nitrate, or any combination thereof.

The insulation layer 150 inhibits or at least partially prevents thermal losses from the reactor 100. In some embodiments, the insulation layer 150 can be composed of an insulative material. In some embodiments, the insulation layer 150 can be composed of a refractory material. In some embodiments, the insulation layer 150 can include periclase. In some embodiments, the insulation layer 150 can include a silica-based refractory material. In some embodiments, the insulation layer 150 can include an alumina-based refractory material. In some embodiments, the insulation layer 150 can include a fibrous material. In some embodiments, the insulation layer 150 can include fiberglass, mineral wool, cellulose, natural fibers, cementitious foam, polyurethane, perlite, polystyrene, polyisocyanurate, or any combination thereof. In some embodiments, the insulation layer 150 can be disposed about the furnace 130 symmetrically such that an equal thickness of the insulation layer 150 covers the exterior surface area of the furnace 130.

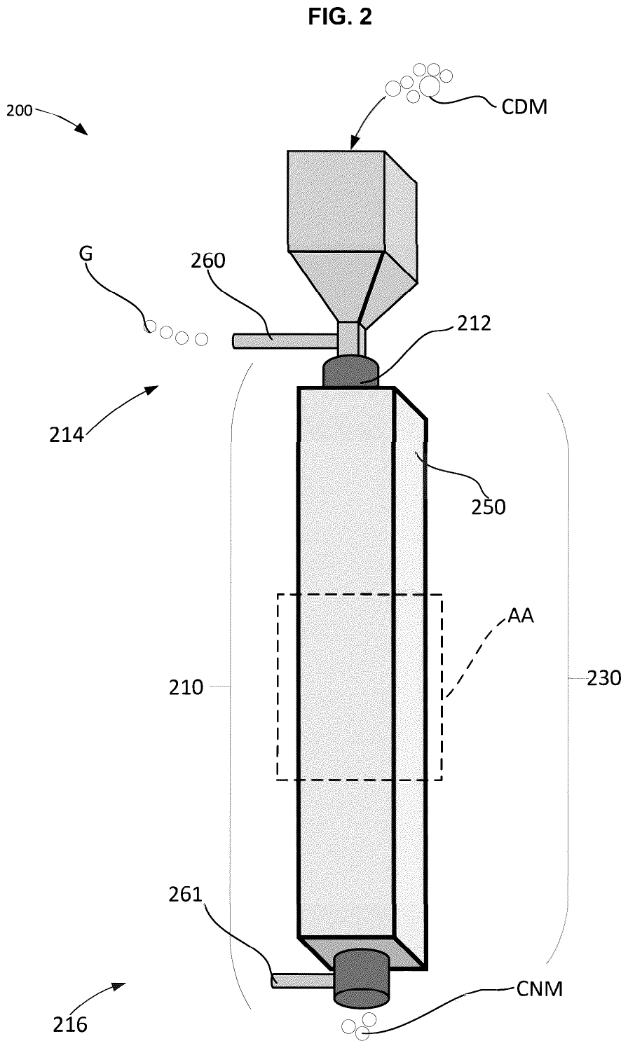

FIG. 2 is an illustration of a high-temperature decomposition reactor 200 (hereinafter “reactor 200”), according to an embodiment. As shown, the reactor 200 includes a reaction vessel 210, a furnace 230, and an insulation layer 250. In some embodiments, the reaction vessel 210, the furnace 230, and the insulation layer 250 can be the same or substantially similar to the reaction vessel 110, the furnace 130, and the insulation layer 150, as described above with reference to FIG. 1. Thus, certain aspects of the reaction vessel 210, the furnace 230, and the insulation layer 250 are not described in greater detail herein.

In use, carbonated medium CDM enters an inner volume 212 of the reaction vessel 210 at a first vessel end 214. As the carbonated medium CDM is heated within the inner volume 212, the carbonated medium CDM is separated (e.g., decomposed) into a carbonation medium CNM and a gas G. The carbonation medium CNM exits the reaction vessel 210 at a second vessel end 216.

The gas G exits the reaction vessel 210 via a conduit 260 fluidly coupled to the inner volume 212. While the conduit 260 is shown positioned proximate to the first vessel end 214, the conduit 260 may be disposed at any position along the length of the reaction vessel 210 between the first vessel end 214 and the second vessel end 216. In some implementations, the conduit 260 is in fluid communication with a sequestration space (e.g., CO₂ sequestration space) positioned at an end of the conduit 260 opposite the inner volume 212. An optional sweep gas inlet 261 is shown near the second vessel end 216.

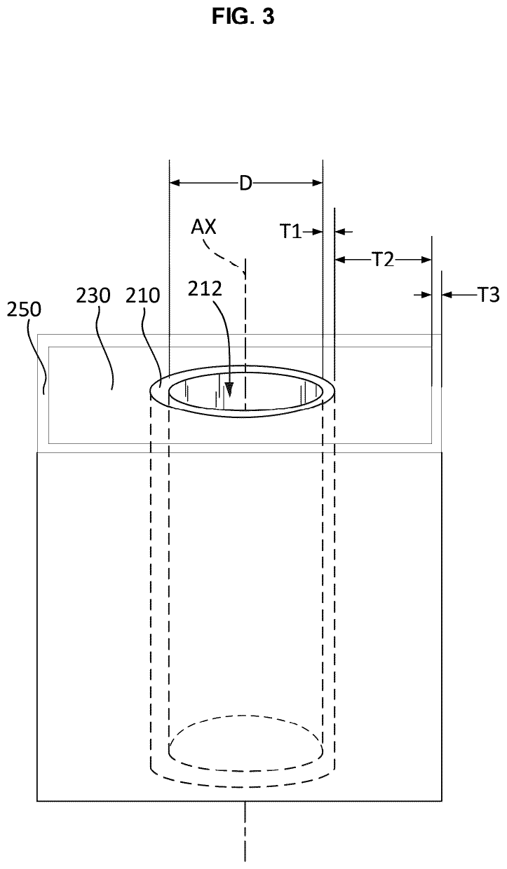

FIG. 3 is a detailed illustration of a portion of the reactor 200 of FIG. 2, as viewed along view window AA. Heat permeates into the inner volume 212 to facilitate calcination. In some embodiments, the heat that permeates into the inner volume 212 can be a direct product solar energy. In some embodiments, the heat that permeates into the inner volume 212 can be a product of energy collected on solar cells and/or solar panels. In other words, electricity collected via solar cells and/or solar panels can be converted to heat. In some embodiments, the heat that permeates into the inner volume 212 is a product of wind energy. In other words, electricity collected via wind energy can be converted to heat.

In some embodiments, the reaction vessel 210 can be composed of a metal. In some embodiments, the reaction vessel 210 can be composed of a conductive metal. In some embodiments, the reaction vessel 210 can be composed of stainless steel, 304 stainless steel, 316 stainless steel, aluminum, iron, wrought iron, cast iron, brass, tin, copper, antimony, or any combination thereof. In some embodiments, the reaction vessel 210 can be composed of an alloy. In some embodiments, the reaction vessel 210 can be composed of a copper-containing alloy. In some embodiments, the reaction vessel 210 can be composed of an aluminum-containing alloy. In some embodiments, the reaction vessel 210 can be formed via extrusion. In some embodiments, the reaction vessel 210 can be formed via welding of a metal sheet. In some embodiments, the reaction vessel 210 can be formed via electric resistance welding (ERW) of a metal sheet. In some embodiments, the reaction vessel 210 can be formed via acetylene torch welding of a metal sheet.

In some embodiments, the reaction vessel 210 includes a substantially cylindrical (e.g., annular, round, circular, etc.) body centered on an axis AX. In some embodiments, the reaction vessel 210 can have an elliptical, or similarly rotationally symmetrical cross-sectional shape centered on the axis AX and extending between the first vessel end 214 and the second vessel end 216.

The reaction vessel 210 has a diameter D, measured as inner diameter of the reaction vessel 210. The diameter D may be between about 50 cm and about 10 m. In some embodiments, the diameter D can be at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, at least about 4.5 m, at least about 5 m, at least about 5.5 m, at least about 6 m, at least about 6.5 m, at least about 7 m, at least about 7.5 m, at least about 8 m, at least about 8.5 m, at least about 9 m, at least about 9.5 m, or at least about 10 m. In some embodiments, the diameter D can be no more than about 10 m, no more than about 9.5 m, no more than about 9 m, no more than about 8.5 m, no more than about 8 m, no more than about 7.5 m, no more than about 7 m, no more than about 6.5 m, no more than about 6 m, no more than about 5.5 m, no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, or no more than about 50 cm. Combinations of the above-referenced diameter D values are also possible (e.g., at least about 50 cm and no more than about 10 m or at least about 2 m and no more than about 6 m), inclusive of all values and ranges therebetween. In some embodiments, the diameter D can be about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, about 5 m, about 5.5 m, about 6 m, about 6.5 m, about 7 m, about 7.5 m, about 8 m, about 8.5 m, about 9 m, about 9.5 m, or about 10 m.

The reaction vessel 210 has a wall thickness T1, measured as the radial thickness between an inner surface of the reaction vessel 210 (e.g., vessel surface nearest the axis AX) and an outer surface of the reaction vessel 210 (e.g., vessel surface furthest from the axis AX; vessel surface abutting the furnace 230). In some embodiments, the wall thickness T1 can be between about 1 mm and about 50 cm, inclusive.

In some embodiments, the wall thickness T1 can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, at least about 19 cm, at least about 20 cm, at least about 21 cm, at least about 22 cm, at least about 23 cm, at least about 24 cm, at least about 25 cm, at least about 26 cm, at least about 27 cm, at least about 28 cm, at least about 29 cm, at least about 30 cm, at least about 31 cm, at least about 32 cm, at least about 33 cm, at least about 34 cm, at least about 35 cm, at least about 36 cm, at least about 37 cm, at least about 38 cm, at least about 39 cm, at least about 40 cm, at least about 41 cm, at least about 42 cm, at least about 43 cm, at least about 44 cm, at least about 45 cm, at least about 46 cm, at least about 47 cm, at least about 48 cm, at least about 49 cm, or at least about 50 cm. In some embodiments, the wall thickness T1 can be no more than about 50 cm, no more than about 49 cm, no more than about 48 cm, no more than about 47 cm, no more than about 46 cm, no more than about 45 cm, no more than about 44 cm, no more than about 43 cm, no more than about 42 cm, no more than about 41 cm, no more than about 40 cm, no more than about 39 cm, no more than about 38 cm, no more than about 37 cm, no more than about 36 cm, no more than about 35 cm, no more than about 34 cm, no more than about 33 cm, no more than about 32 cm, no more than about 31 cm, no more than about 30 cm, no more than about 29 cm, no more than about 28 cm, no more than about 27 cm, no more than about 26 cm, no more than about 25 cm, no more than about 24 cm, no more than about 23 cm, no more than about 22 cm, no more than about 21 cm, no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced thicknesses are also possible (e.g., at least about 1 mm and no more than about 50 cm or at least about 4 cm and no more than about 25 cm), inclusive of all values and ranges therebetween. In some embodiments, the wall thickness T1 can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 26 cm, about 27 cm, about 28 cm, about 29 cm, about 30 cm, about 31 cm, about 32 cm, about 33 cm, about 34 cm, about 35 cm, about 36 cm, about 37 cm, about 38 cm, about 39 cm, about 40 cm, about 41 cm, about 42 cm, about 43 cm, about 44 cm, about 45 cm, about 46 cm, about 47 cm, about 48 cm, about 49 cm, or about 50 cm.

In some embodiments, the furnace 230 includes a substantially cylindrical (e.g., annular, round, circular, etc.) body centered on the axis AX and disposed around the reaction vessel 210. In some embodiments, the furnace 230 includes an elliptical or similarly rotationally symmetrical cross-sectional shape centered on the axis AX and extending between the first vessel end 214 and the second vessel end 216. In some embodiments, a cross-sectional shape of the furnace 230 is different from a cross-sectional shape of the reaction vessel 210.

The furnace 230 further includes a furnace thickness T2, measured as the radial thickness between an inner surface of the furnace 230 (e.g., furnace surface nearest the axis AX; furnace surface abutting the reaction vessel 210) and an outer surface of the furnace 230 (e.g., furnace surface furthest from the axis AX; furnace surface abutting the insulation layer 250). The furnace thickness T2 can be between about 5 cm and about 10 m, inclusive.

In some embodiments, the furnace thickness T2 can be at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 2 m, at least about 3 m, at least about 4 m, at least about 5 m, at least about 6 m, at least about 7 m, at least about 8 m, at least about 9 m, or at least about 10 m. In some embodiments, the furnace thickness T2 can be no more than about 10 m, no more than about 9 m, no more than about 8 m, no more than about 7 m, no more than about 6 m, no more than about 5 m, no more than about 4 m, no more than about 3 m, no more than about 2 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, or no more than about 5 cm. Combinations of the above-referenced thickness values are also possible (e.g., at least about 5 cm and no more than about 10 m or at least about 40 cm and no more than about 80 cm), inclusive of all values and ranges therebetween. In some embodiments, the furnace thickness T2 can measure about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, or about 10 m.

The furnace 230 has a porosity ((D; percent), measured as the void volume divided by the total volume, where a porosity equal to zero percent is a solid object. In some embodiments, the porosity of the furnace 230 is evenly distributed throughout the furnace 230. In some embodiments, the porosity of the furnace is asymmetrically distributed or randomly distributed throughout the furnace 230. In some embodiments, the porosity of the furnace 230 changes dependent on the distance the furnace 230 is from the axis AX. For example, portions of the furnace 230 positioned radially further from the axis AX may have a lesser porosity than portions of the furnace 230 positioned radially nearer to the axis AX and abutting the reaction vessel 210. The porosity of the furnace 230 can be between 0% and 95%, inclusive.

In some embodiments, the porosity of the furnace 230 is 0%. In some embodiments, the porosity of the furnace 230 is at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, at least about 91%, at least about 92%, at least about 93%, at least about 94%, or at least about 95%. In some embodiments, the furnace 230 can have a porosity of no more than about 95%, no more than about 94%, no more than about 93%, no more than about 92%, no more than about 91%, no more than about 90%, no more than about 80%, no more than about 70%, no more than about 60%, no more than about 50%, no more than about 40%, no more than about 30%, no more than about 20%, no more than about 10%, no more than about 9%, no more than about 8%, no more than about 7%, no more than about 6%, no more than about 5%, no more than about 4%, no more than about 3%, no more than about 2%, no more than about 1%, no more than about 0.9%, no more than about 0.8%, no more than about 0.7%, no more than about 0.6%, no more than about 0.5%, no more than about 0.4%, no more than about 0.3%, no more than about 0.2%, or no more than about 0.1%. Combinations of the above-referenced porosity values are also possible (e.g., at least about 0.1% and no more than about 95% or at least about 15% and no more than about 40%), inclusive of all values and ranges therebetween. In some embodiments, the porosity of the furnace 230 is about 0%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, about 91%, about 92%, about 93%, about 94%, or about 95%.

In some embodiments, the insulation layer 250 includes a substantially cylindrical (e.g., annular, round, circular, etc.) body centered on the axis AX and disposed around the furnace 230. In some embodiments, the insulation layer 250 includes an elliptical or similarly rotationally symmetrical cross-sectional shape centered on the axis AX and extending between the first vessel end 214 and the second vessel end 216. In some embodiments, a cross-sectional shape of the insulation layer 250 is different from a cross-sectional shape of the furnace 230.

The insulation layer 250 further includes an insulation thickness T3, measured as the radial thickness between an inner surface of the insulation layer 250 (e.g., insulation layer surface nearest the axis AX; insulation layer surface abutting the furnace 230) and an outer surface of the insulation layer 270 (e.g., insulation layer surface furthest from the axis AX; insulation layer surface exposed to an ambient environment). The insulation thickness T3 may be between 1 centimeter (cm) and 3 meters (m), inclusive.

In some embodiments, the insulation thickness T3 can be at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 2 m, or at least about 3 m. In some embodiments, the insulation thickness T3 can be no more than about 3 m, no more than about 2 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, or no more than about 1 cm. Combinations of the above-referenced thickness values are also possible (e.g., at least about 1 cm and no more than about 3 m or at least about 10 cm and no more than about 60 cm), inclusive of all values and ranges therebetween. In some embodiments, the insulation thickness T3 can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 2 m, or about 3 m.

The insulation layer 250 further includes a porosity (<D; percent), measured as the void volume divided by the total volume, where a porosity equal to zero percent is a solid object. In some embodiments, the porosity of the insulation layer 250 is evenly distributed throughout the insulation layer 250. In some embodiments, the porosity of the insulation later 250 is asymmetrically distributed or randomly distributed throughout the insulation later 250. In some embodiments, the porosity of the insulation layer 250 changes dependent on the distance the insulation layer 250 is from the axis 270. For example, portions of the insulation layer 250 positioned radially further from the axis 270 may have a lesser porosity than portions of the insulation layer 250 positioned radially nearer to the axis 270 and abutting the furnace 230. The porosity of the insulation layer 250 can be between 0% and 95%, inclusive.

In some embodiments, the porosity of the insulation layer 250 is 0%. In some embodiments, the porosity of the furnace 230 is at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, at least about 91%, at least about 92%, at least about 93%, at least about 94%, or at least about 95%. In some embodiments, the insulation layer 250 can have a porosity of no more than about 95%, no more than about 94%, no more than about 93%, no more than about 92%, no more than about 91%, no more than about 90%, no more than about 80%, no more than about 70%, no more than about 60%, no more than about 50%, no more than about 40%, no more than about 30%, no more than about 20%, no more than about 10%, no more than about 9%, no more than about 8%, no more than about 7%, no more than about 6%, no more than about 5%, no more than about 4%, no more than about 3%, no more than about 2%, no more than about 1%, no more than about 0.9%, no more than about 0.8%, no more than about 0.7%, no more than about 0.6%, no more than about 0.5%, no more than about 0.4%, no more than about 0.3%, no more than about 0.2%, or no more than about 0.1%. Combinations of the above-referenced porosity values are also possible (e.g., at least about 0.1% and no more than about 95% or at least about 15% and no more than about 40%), inclusive of all values and ranges therebetween. In some embodiments, the porosity of the insulation layer 250 can be about 0%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, about 91%, about 92%, about 93%, about 94%, or about 95%.

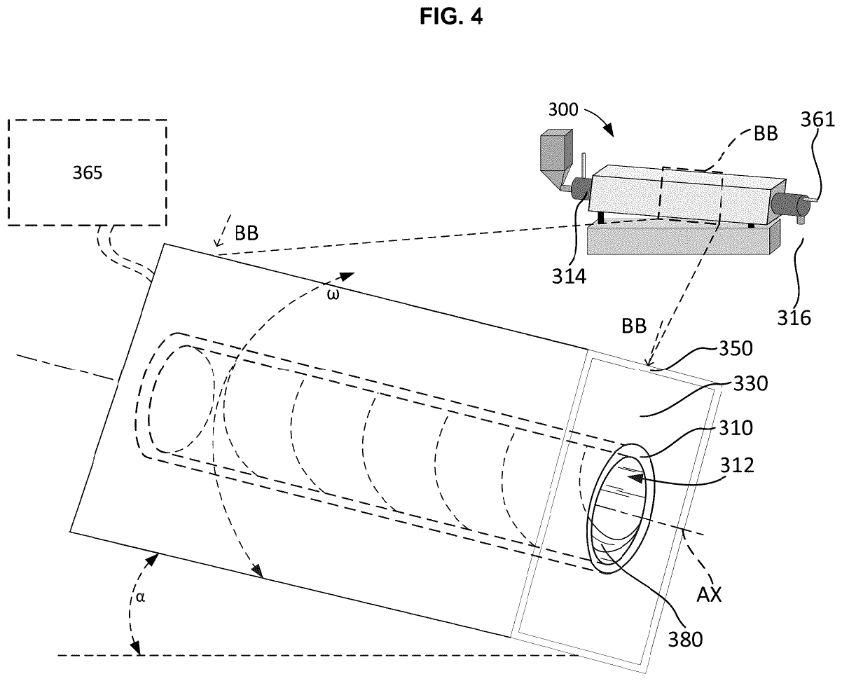

FIG. 4 is an illustration of a portion high-temperature decomposition reactor 300 (hereinafter “reactor 300”) shown through viewing window BB, according to an embodiment. As shown, the reactor 300 includes a reaction vessel 310, a furnace 330, and an insulating layer 350. The reaction vessel 310 includes an inner volume 312, a first vessel end 314, and a second vessel end 316. In some embodiments, the reaction vessel 310, the inner volume 312, the first vessel end 314, the second vessel end 316, the furnace 330, and the insulating layer 350 can be the same or substantially similar to the reaction vessel 210, the inner volume 212, the first vessel end 214, the second vessel end 216, the furnace 230, and the insulating layer 250, as described above with reference to FIG. 2 and FIG. 3. Thus, certain aspects of the reaction vessel 310, the inner volume 312, the first vessel end 314, the second vessel end 316, the furnace 330, and the insulating layer 350 are not described in greater detail herein.

Carbonated medium enters the inner volume 312 of the reaction vessel 310 through the first vessel end 314 and/or the second vessel end 316. As the carbonated medium is heated within the inner volume 312, the carbonated medium is separated (e.g., decomposed) into a carbonation media and a gas. The carbonation medium exits the reaction vessel 310 via the first vessel end 314 and/or the second vessel end 316. An optional sweep gas inlet 361 is shown near the second vessel end 316.

The reactor 300 may be positioned horizontally, such that a central axis AX of the reactor 300 extends parallel to the ground. In some embodiments, the reactor 300 is positioned at a non-zero angle α, measured between the ground and the axis AX. The angle α may be between about 0 and about 90 degrees, inclusive. In some embodiments, the angle α can at least about 1 degree, at least about 2 degrees, at least about 3 degrees, at least about 4 degrees, at least about 5 degrees, at least about 6 degrees, at least about 7 degrees, at least about 8 degrees, at least about 9 degrees, at least about 10 degrees, at least about 20 degrees, at least about 21 degrees, at least about 22 degrees, at least about 23 degrees, at least about 24 degrees, at least about 25 degrees, at least about 26 degrees, at least about 27 degrees, at least about 28 degrees, at least about 29 degrees, at least about 30 degrees, at least about 31 degrees, at least about 32 degrees, at least about 33 degrees, at least about 34 degrees, at least about 35 degrees, at least about 40 degrees, at least about 50 degrees, at least about 60 degrees, at least about 70 degrees, at least about 80 degrees, or at least about 89 degrees. In some embodiments, the angle α can be no more than about 89 degrees, no more than about 80 degrees, no more than about 70 degrees, no more than about 60 degrees, no more than about 50 degrees, no more than about 40 degrees, no more than about 35 degrees, no more than about 34 degrees, no more than about 33 degrees, no more than about 32 degrees, no more than about 31 degrees, no more than about 30 degrees, no more than about 29 degrees, no more than about 28 degrees, no more than about 27 degrees, no more than about 26 degrees, no more than about 25 degrees, no more than about 24 degrees, no more than about 23 degrees, no more than about 22 degrees, no more than about 21 degrees, no more than about 20 degrees, no more than about 19 degrees, no more than about 18 degrees, no more than about 17 degrees, no more than about 16 degrees, no more than about 15 degrees, no more than about 14 degrees, no more than about 13 degrees, no more than about 12 degrees, no more than about 11 degrees, no more than about 10 degrees, no more than about 9 degrees, no more than about 8 degrees, no more than about 7 degrees, no more than about 6 degrees, no more than about 5 degrees, no more than about 4 degrees, no more than about 3 degrees, no more than about 2 degrees, or no more than about 1 degree. Combinations of the above-referenced angles are also possible (e.g., at least about 1 degree and no more than about 89 degrees or at least about 10 degrees and no more than about 40 degrees), inclusive of all values and ranges therebetween. In some embodiments, the angle α is about 1 degree, about 2 degrees, about 3 degrees, about 4 degrees, about 5 degrees, about 6 degrees, about 7 degrees, about 8 degrees, about 9 degrees, about 10 degrees, about 20 degrees, about 21 degrees, about 22 degrees, about 23 degrees, about 24 degrees, about 25 degrees, about 26 degrees, about 27 degrees, about 28 degrees, about 29 degrees, about 30 degrees, about 31 degrees, about 32 degrees, about 33 degrees, about 34 degrees, about 35 degrees, about 40 degrees, about 50 degrees, about 60 degrees, about 70 degrees, about 80 degrees, or about 89 degrees.

The reactor 300 can optionally include a facilitation device 380 positioned within (e.g., disposed within) the reaction vessel 310. The facilitation device 380 is configured to move (e.g., facilitate the movement of) the carbonated media and the carbonation media within the reaction vessel 310 between the first vessel end 314 and the second vessel end 316. In some instances, as shown in FIG. 4, the facilitation device 380 extends radially inward from an inner wall of the reaction vessel 310 toward a central axis 370. The facilitation device 380 may be an Archimedes Screw or a similar device configured to move a medium (e.g., carbonated medium, carbonation medium, etc.) from a first position to a second position when the reaction vessel 310 rotates about the axis AX. In some embodiments, the second position is at a higher potential energy state than the first position. In some embodiments, the second position is at a lower potential energy state than the first position. In some embodiments, the facilitation device 380 is structured such that a counterclockwise rotation of the reactor 300 about the axis AX facilitates movement of material within the reaction vessel 310 from the first vessel end 314 to the second vessel end 316. In some embodiments, the facilitation device 380 is structured such that a clockwise rotation of the reactor 300 about the axis AX facilitates movement of material within the reaction vessel 310 from the first vessel end 314 to the second vessel end 316. In some embodiments, the facilitation device 380 is structured such that a counterclockwise rotation of the reactor 300 about the axis 380 facilitates movement of material within the reaction vessel 310 from the second vessel end 316 to the first vessel end 314. In some embodiments, the facilitation device 380 is structured such that a clockwise rotation of the reactor 300 about the axis 380 facilitates movement of material within the reaction vessel 310 from the second vessel end 316 to the first vessel end 314.

The reactor 300 further includes a rotational mechanism 365 operatively coupled to the reactor 300 and configured to rotate the reactor 300 about the axis 370. In some embodiments, the rotational mechanism is operatively coupled to the facilitation device 380 and configured to rotate the facilitation device 380 about the axis 370 and relative to the reactor 300. The rotational mechanism 365 may be an actuator, a pair of rollers, a motor, and the like. The rotational mechanism 365 is configured to rotate the reactor 300 at a rotational velocity ω.

The reactor 300 can be rotated at a rotational velocity of ω about the axis 370. In some embodiments, the rotational velocity ω is between about 0.1 rotations per minute (rpm) and about 10 rpm. In some embodiments, the rotational velocity ω is at least about 0.1 rpm, at least about 0.2 rpm, at least about 0.3 rpm, at least about 0.4 rpm, at least about 0.5 rpm, at least about 0.6 rpm, at least about 0.7 rpm, at least about 0.8 rpm, at least about 0.9 rpm, at least about 1 rpm, at least about 2 rpm, at least about 3 rpm, at least about 4 rpm, at least about 5 rpm, at least about 6 rpm, at least about 7 rpm, at least about 8 rpm, at least about 9 rpm, or at least about 10 rpm. In some embodiments, the rotational velocity ω can be no more than about 10 rpm, no more than about 9 rpm, no more than about 8 rpm, no more than about 7 rpm, no more than about 6 rpm, no more than about 5 rpm, no more than about 4 rpm, no more than about 3 rpm, no more than about 2 rpm, no more than about 1 rpm, no more than about 0.9 rpm, no more than about 0.8 rpm, no more than about 0.7 rpm, no more than about 0.6 rpm, no more than about 0.5 rpm, no more than about 0.4 rpm, no more than about 0.3 rpm, no more than about 0.2 rpm, or no more than about 0.1 rpm. Combinations of the above-referenced rotational velocities are also possible (e.g., at least about 0.1 rpm and no more than about 10 rpm or at least about 0.5 rpm and no more than about 5 rpm), inclusive of all values and ranges therebetween. In some embodiments, the rotational velocity ω is about 0.1 rpm, about 0.2 rpm, about 0.3 rpm, about 0.4 rpm, about 0.5 rpm, about 0.6 rpm, about 0.7 rpm, about 0.8 rpm, about 0.9 rpm, about 1 rpm, about 2 rpm, about 3 rpm, about 4 rpm, about 5 rpm, about 6 rpm, about 7 rpm, about 8 rpm, about 9 rpm, or about 10 rpm.

The reactor 300 can decompose an amount of carbonated medium in a unit of time, represented as a carbonated medium throughput, and measured as metric tonnes (i.e., metric tonnes, or 1,000 kg) of carbonated medium per hour. In some embodiments, the carbonated medium throughput is at least about 0.1 tonne per hour, at least about 0.2 tonnes per hour, at least about 0.3 tonnes per hour, at least about 0.4 tonnes per hour, at least about 0.5 tonnes per hour, at least about 0.6 tonnes per hour, at least about 0.7 tonnes per hour, at least about 0.8 tonnes per hour, at least about 0.9 tonnes per hour, at least about 1 tonne per hour, at least about 2 tonnes per hour, at least about 3 tonnes per hour, at least about 4 tonnes per hour, at least about 5 tonnes per hour, at least about 6 tonnes per hour, at least about 7 tonnes per hour, at least about 8 tonnes per hour, at least about 9 tonnes per hour, at least about 10 tonnes per hour, at least about 20 tonnes per hour, at least about 30 tonnes per hour, at least about 40 tonnes per hour, at least about 50 tonnes per hour, at least about 60 tonnes per hour, at least about 70 tonnes per hour, at least about 80 tonnes per hour, at least about 90 tonnes per hour, at least about 100 tonnes per hour, at least about 200 tonnes per hour, at least about 500 tonnes per hour, at least about 1,000 tonnes per hour, or at least about 5,000 tonnes per hour. In some embodiments, the carbonated medium throughput is no more than about 5,000 tonnes per hour, no more than about 1,000 tonnes per hour, no more than about 500 tonnes per hour, no more than about 200 tonnes per hour, no more than about 100 tonnes per hour, no more than about 90 tonnes per hour, no more than about 80 tonnes per hour, no more than about 70 tonnes per hour, no more than about 60 tonnes per hour, no more than about 50 tonnes per hour, no more than about 40 tonnes per hour, no more than about 30 tonnes per hour, no more than about 20 tonnes per hour, no more than about 10 tonnes per hour, no more than about 9 tonnes per hour, no more than about 8 tonnes per hour, no more than about 7 tonnes per hour, no more than about 6 tonnes per hour, no more than about 5 tonnes per hour, no more than about 4 tonnes per hour, no more than about 3 tonnes per hour, no more than about 2 tonnes per hour, no more than about 1 tonne per hour, no more than about 0.9 tonnes per hour, no more than about 0.8 tonnes per hour, no more than about 0.7 tonnes per hour, no more than about 0.6 tonnes per hour, no more than about 0.5 tonnes per hour, no more than about 0.4 tonnes per hour, no more than about 0.3 tonnes per hour, no more than about 0.2 tonnes per hour, or no more than about 0.1 tonnes per hour. Combinations of the above-referenced throughput values are also possible (e.g., at least about 0.1 tonnes per hour and no more than about 5,000 tonnes per hour or at least about 2 tonnes per hour and no more than about 50 tonnes per hour), inclusive of all values and ranges therebetween. In some embodiments, the carbonated medium throughput is about 0.1 tonnes per hour, about 0.2 tonnes per hour, about 0.3 tonnes per hour, about 0.4 tonnes per hour, about 0.5 tonnes per hour, about 0.6 tonnes per hour, about 0.7 tonnes per hour, about 0.8 tonnes per hour, about 0.9 tonnes per hour, about 1 tonne per hour, about 2 tonnes per hour, about 3 tonnes per hour, about 4 tonnes per hour, about 5 tonnes per hour, about 6 tonnes per hour, about 7 tonnes per hour, about 8 tonnes per hour, about 9 tonnes per hour, about 10 tonnes per hour, about 20 tonnes per hour, about 30 tonnes per hour, about 40 tonnes per hour, about 50 tonnes per hour, about 60 tonnes per hour, about 70 tonnes per hour, about 80 tonnes per hour, about 90 tonnes per hour, about 100 tonnes per hour, about 200 tonnes per hour, about 500 tonnes per hour, about 1000 tonnes per hour, or about 5000 tonnes per hour.

The reactor 300 can generate an amount of carbon dioxide (CO₂) from the carbonated medium in a unit of time, represented as a CO₂ sequestration capacity, and measured as metric tonnes of CO₂ per hour.

In some embodiments, the CO₂ sequestration capacity of the reactor 300 (i.e., the amount of CO₂ the reactor 300 can sequester) is at least about 0.01 tonnes per hour, at least about 0.02 tonnes per hour, at least about 0.03 tonnes per hour, at least about 0.04 tonnes per hour, at least about 0.05 tonnes per hour, at least about 0.06 tonnes per hour, at least about 0.07 tonnes per hour, at least about 0.08 tonnes per hour, at least about 0.09 tonnes per hour, at least about 0.1 tonnes per hour, at least about 0.2 tonnes per hour, at least about 0.3 tonnes per hour, at least about 0.4 tonnes per hour, at least about 0.5 tonnes per hour, at least about 0.6 tonnes per hour, at least about 0.7 tonnes per hour, at least about 0.8 tonnes per hour, at least about 0.9 tonnes per hour, at least about 1 tonne per hour, at least about 2 tonnes per hour, at least about 3 tonnes per hour, at least about 4 tonnes per hour, at least about 5 tonnes per hour, at least about 6 tonnes per hour, at least about 7 tonnes per hour, at least about 8 tonnes per hour, at least about 9 tonnes per hour, at least about 10 tonnes per hour, at least about 20 tonnes per hour, at least about 50 tonnes per hour, at least about 100 tonnes per hour, or at least about 500 tonnes per hour. In some embodiments, the CO₂ sequestration capacity of the reactor 300 is no more than about 500 tonnes per hour, no more than about 100 tonnes per hour, no more than about 50 tonnes per hour, no more than about 20 tonnes per hour, no more than about 10 tonnes per hour, no more than about 9 tonnes per hour, no more than about 8 tonnes per hour, no more than about 7 tonnes per hour, no more than about 6 tonnes per hour, no more than about 5 tonnes per hour, no more than about 4 tonnes per hour, no more than about 3 tonnes per hour, no more than about 2 tonnes per hour, no more than about 1 tonne per hour, no more than about 0.9 tonnes per hour, no more than about 0.8 tonnes per hour, no more than about 0.7 tonnes per hour, no more than about 0.6 tonnes per hour, no more than about 0.5 tonnes per hour, no more than about 0.4 tonnes per hour, no more than about 0.3 tonnes per hour, no more than about 0.2 tonnes per hour, no more than about 0.1 tonne per hour, no more than about 0.09 tonnes per hour, no more than about 0.08 tonnes per hour, no more than about 0.07 tonnes per hour, no more than about 0.06 tonnes per hour, no more than about 0.05 tonnes per hour, no more than about 0.04 tonnes per hour, no more than about 0.03 tonnes per hour, no more than about 0.02 tonnes per hour, or no more than about 0.01 tonnes per hour. Combinations of the above-referenced sequestration capacities are also possible (e.g., at least about 0.01 tonnes per hour and no more than about 500 tonnes per hour or at least about 0.1 tonnes per hour and no more than about 5 tonnes per hour), inclusive of all values and ranges therebetween. In some embodiments, the CO₂ sequestration capacity of the reactor 300 is no more than 0.1 tonnes per hour, no more than 0.2 tonnes per hour, no more than 0.3 tonnes per hour, no more than 0.4 tonnes per hour, no more than 0.5 tonnes per hour, no more than 0.6 tonnes per hour, no more than 0.7 tonnes per hour, no more than 0.8 tonnes per hour, no more than 0.9 tonnes per hour, no more than 1 tonne per hour, no more than 2 tonnes per hour, no more than 3 tonnes per hour, no more than 4 tonnes per hour, no more than 5 tonnes per hour, no more than 6 tonnes per hour, no more than 7 tonnes per hour, no more than 8 tonnes per hour, no more than 9 tonnes per hour, no more than 10 tonnes per hour, no more than 20 tonnes per hour, no more than 30 tonnes per hour, no more than 40 tonnes per hour, no more than 50 tonnes per hour, no more than 60 tonnes per hour, no more than 70 tonnes per hour, no more than 80 tonnes per hour, no more than 90 tonnes per hour, no more than 100 tonnes per hour, no more than 200 tonnes per hour, no more than 500 tonnes per hour, no more than 1000 tonnes per hour, or no more than 5000 tonnes per hour. In some embodiments, the CO₂ sequestration capacity of the reactor 300 is about 0.01 tonnes per hour, about 0.02 tonnes per hour, about 0.03 tonnes per hour, about 0.04 tonnes per hour, about 0.05 tonnes per hour, about 0.06 tonnes per hour, about 0.07 tonnes per hour, about 0.08 tonnes per hour, about 0.09 tonnes per hour, about 0.1 tonnes per hour, about 0.2 tonnes per hour, about 0.3 tonnes per hour, about 0.4 tonnes per hour, about 0.5 tonnes per hour, about 0.6 tonnes per hour, about 0.7 tonnes per hour, about 0.8 tonnes per hour, about 0.9 tonnes per hour, about 1 tonne per hour, about 2 tonnes per hour, about 3 tonnes per hour, about 4 tonnes per hour, about 5 tonnes per hour, about 6 tonnes per hour, about 7 tonnes per hour, about 8 tonnes per hour, about 9 tonnes per hour, about 10 tonnes per hour, about 20 tonnes per hour, about 50 tonnes per hour, about 100 tonnes per hour, or about 500 tonnes per hour.

The reactor 300 can produce an amount of carbonation medium in a unit of time, represented as a carbonation medium throughput, and measured as metric tonnes of carbonation medium per hour. In some embodiments, the carbonation medium production is at least about 0.1 tonnes per hour, at least about 0.2 tonnes per hour, at least about 0.3 tonnes per hour, at least about 0.4 tonnes per hour, at least about 0.5 tonnes per hour, at least about 0.6 tonnes per hour, at least about 0.7 tonnes per hour, at least about 0.8 tonnes per hour, at least about 0.9 tonnes per hour, at least about 1 tonne per hour, at least about 2 tonnes per hour, at least about 3 tonnes per hour, at least about 4 tonnes per hour, at least about 5 tonnes per hour, at least about 6 tonnes per hour, at least about 7 tonnes per hour, at least about 8 tonnes per hour, at least about 9 tonnes per hour, at least about 10 tonnes per hour, at least about 20 tonnes per hour, at least about 30 tonnes per hour, at least about 40 tonnes per hour, at least about 50 tonnes per hour, at least about 60 tonnes per hour, at least about 70 tonnes per hour, at least about 80 tonnes per hour, at least about 90 tonnes per hour, at least about 100 tonnes per hour, at least about 200 tonnes per hour, at least about 500 tonnes per hour, at least about 1000 tonnes per hour, or at least about 5000 tonnes per hour.

In some embodiments, the carbonated medium throughput is no more than about 5,000 tonnes per hour, no more than about 1,000 tonnes per hour, no more than about 500 tonnes per hour, no more than about 200 tonnes per hour, no more than about 100 tonnes per hour, no more than about 90 tonnes per hour, no more than about 80 tonnes per hour, no more than about 70 tonnes per hour, no more than about 60 tonnes per hour, no more than about 50 tonnes per hour, no more than about 40 tonnes per hour, no more than about 30 tonnes per hour, no more than about 20 tonnes per hour, no more than about 10 tonnes per hour, no more than about 9 tonnes per hour, no more than about 8 tonnes per hour, no more than about 7 tonnes per hour, no more than about 6 tonnes per hour, no more than about 5 tonnes per hour, no more than about 4 tonnes per hour, no more than about 3 tonnes per hour, no more than about 2 tonnes per hour, no more than about 1 tonne per hour, no more than about 0.9 tonnes per hour, no more than about 0.8 tonnes per hour, no more than about 0.7 tonnes per hour, no more than about 0.6 tonnes per hour, no more than about 0.5 tonnes per hour, no more than about 0.4 tonnes per hour, no more than about 0.3 tonnes per hour, no more than about 0.2 tonnes per hour, or no more than about 0.1 tonnes per hour. Combinations of the above-referenced throughputs are also possible (e.g., at least about 0.1 tonnes per hour and no more than about 5,000 tonnes per hour or at least about 5 tonnes per hour and no more than about 50 tonnes per hour), inclusive of all values and ranges therebetween. In some embodiments, the carbonation medium throughput is about 0.1 tonnes per hour, about 0.2 tonnes per hour, about 0.3 tonnes per hour, about 0.4 tonnes per hour, about 0.5 tonnes per hour, about 0.6 tonnes per hour, about 0.7 tonnes per hour, about 0.8 tonnes per hour, about 0.9 tonnes per hour, about 1 tonne per hour, about 2 tonnes per hour, about 3 tonnes per hour, about 4 tonnes per hour, about 5 tonnes per hour, about 6 tonnes per hour, about 7 tonnes per hour, about 8 tonnes per hour, about 9 tonnes per hour, about 10 tonnes per hour, about 20 tonnes per hour, about 30 tonnes per hour, about 40 tonnes per hour, about 50 tonnes per hour, about 60 tonnes per hour, about 70 tonnes per hour, about 80 tonnes per hour, about 90 tonnes per hour, about 100 tonnes per hour, about 200 tonnes per hour, about 500 tonnes per hour, about 1000 tonnes per hour, or about 5000 tonnes per hour.

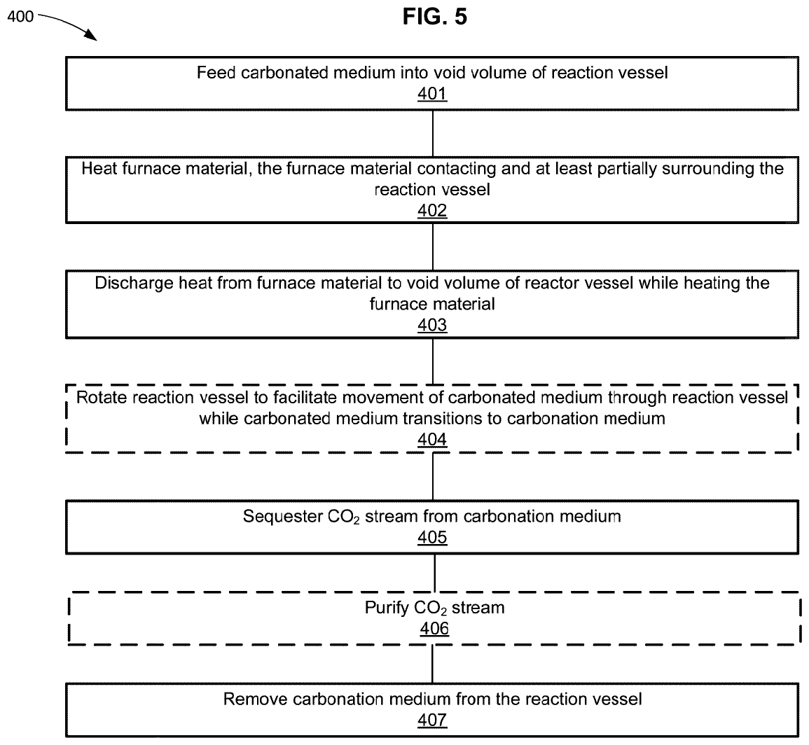

FIG. 5 is a block diagram of a method 400 of decomposing a carbonated medium into a gas and a carbonation medium, according to an embodiment. As shown, the method 400 includes feeding a carbonated medium into an inner volume (e.g., void volume) of a reaction vessel at step 401, heating a furnace material at step 402, and discharging heat from the furnace material to the inner volume of the reactor vessel while heating the furnace material at step 403. Step 404 is optional and includes rotating the reaction vessel to facilitate movement of carbonated medium through the reaction vessel while carbonated medium transitions to carbonation medium. The method 400 further includes sequestering a CO₂ stream from the carbonation medium at step 405, optionally purifying the CO₂ stream at step 406, and removing the carbonation medium from the reaction vessel at step 407.

At step 401, a carbonated medium is provided to an inner volume of a reaction vessel of a high-temperature decomposition reactor. In some instances, the carbonated medium can include limestone, calcite, aragonite, or calcium carbonate (CaCO₃). At step 402, a furnace material of the high-temperature decomposition reactor is heated. The furnace material contacts the reaction vessel and at least partially surrounds the reaction vessel. In some embodiments, the heat provided to the furnace material can be applied at least partially by renewable electricity. For example, the heat can be applied at least partially by renewable electricity via solar power, wind power, nuclear power, geothermal power, and/or any other suitable renewable or low carbon energy source or combinations thereof. In some embodiments, all or substantially all of the heat can be applied by renewable energy.

At step 403, the heat stored in the furnace material is discharged to the inner volume of the reaction vessel. In some implementations, steps 402 and 403 can occur at least partially simultaneously, such that the furnace material is heated while the furnace material is also discharging heat into the inner volume of the reaction vessel. The heat discharged by the furnace material into the inner volume facilitates the decomposition of the carbonated medium disposed within the inner volume.

As an example, the decomposition (e.g., calcination) of calcium carbonate occurs according to the following reaction:

CaCO₃+energy(heat)→CaO+CO₂

In some embodiments, the calcining (e.g., decomposing) temperature can be at least about 500° C., at least about 550° C., at least about 600° C., at least about 650° C., at least about 700° C., at least about 750° C., at least about 800° C., at least about 850° C., at least about 900° C., at least about 950° C., at least about 1,000° C., at least about 1,050° C., at least about 1,100° C., at least about 1,150° C., at least about 1,200° C., at least about 1,250° C., at least about 1,300° C., at least about 1,350° C., at least about 1,400° C., or at least about 1,450° C. In some embodiments, the calcining temperature can be no more than about 1,450° C., no more than about 1,400° C., no more than about 1,350° C., no more than about 1,300° C., no more than about 1,250° C., no more than about 1,200° C., no more than about 1,150° C., no more than about 1,100° C., no more than about 1,050° C., no more than about 1,000° C., no more than about 950° C., no more than about 900° C., no more than about 850° C., no more than about 800° C., no more than about 750° C., no more than about 700° C., no more than about 650° C., no more than about 600° C., or no more than about 550° C. Combinations of the above-referenced calcining temperatures are also possible (e.g., at least about 500° C. and no more than about 1,500° C. or at least about 600° C. and no more than about 800° C.), inclusive of all values and ranges therebetween. In some embodiments, the calcining temperature can be about 500° C., about 550° C., about 600° C., about 650° C., about 700° C., about 750° C., about 800° C., about 850° C., about 900° C., about 950° C., about 1,000° C., about 1,050° C., about 1,100° C., about 1,150° C., about 1,200° C., about 1,250° C., about 1,300° C., about 1,350° C., about 1,400° C., about 1,450° C., or about 1,500° C.

At optional step 404, the reaction vessel is rotated to facilitate the movement of the carbonated medium (i.e., as the carbonated medium decomposes) along the length of the reaction vessel. For example, the reaction vessel may include a facilitation device configured to move the decomposing carbonated medium from a position of high potential energy to a position of low potential energy or from a position of low potential energy to a position of high potential energy. The reaction vessel may be rotated slowly or quickly depending on the heat provided by the furnace material and the amount of carbonated medium disposed within the inner volume. Rotation of the reaction vessel can cooperate with the facilitation device to ensure even heating of the carbonated medium, which may reduce the time required to calcine the carbonated medium, and may reduce the heat requirements to calcine the carbonated medium.

At step 405, the gas (e.g., CO₂) created from the decomposition of the carbonated medium is removed from the inner volume, captured, and sequestered. In some embodiments, the CO₂ stream can naturally flow from the reactor (i.e., without any added compression). In some embodiments, the CO₂ stream can be compressed to desired transport conditions (i.e., a transport pressure) and pumped via pipeline to a storage location. In some embodiments, the transport pressure can be about 2 bar, about 3 bar, about 4 bar, about 5 bar, about 6 bar, about 7 bar, about 8 bar, about 9 bar, about 10 bar, about 15 bar, about 20 bar, about 25 bar, about 30 bar, about 35 bar, about 40 bar, about 45 bar, about 50 bar, about 55 bar, about 60 bar, about 65 bar, about 70 bar, about 75 bar, about 80 bar, about 85 bar, about 90 bar, about 95 bar, about 100 bar, about 110 bar, about 120 bar, about 130 bar, about 140 bar, about 150 bar, about 160 bar, about 170 bar, about 180 bar, about 190 bar, or about 200 bar, inclusive of all values and ranges therebetween.

In some embodiments, the CO₂ stream can be subject to post-processing prior to storage such that the CO₂ stream is compliant with applicable specifications for storage. In some embodiments, the post-processing can include dehydration (e.g., via a condenser) and/or compression (e.g., via a compressor).

Step 406 is optional and includes purifying the CO₂ stream. In some embodiments, the CO₂ stream can be purified via condensation of water or other post processing treatment. In some embodiments, the CO₂ stream can be compressed into gas storage. In some embodiments, the compressed CO₂ stream can be direct injected in a co-located facility. In some embodiments, the compressed CO₂ stream can be transported to a location where it can be sequestered. In some embodiments, the CO₂ stream can have a high purity. In some embodiments, the CO₂ stream can include at least about 80 vol %, at least about 85 vol %, at least about 90 vol %, at least about 91 vol %, at least about 92 vol %, at least about 93 vol %, at least about 94 vol %, at least about 95 vol %, at least about 96 vol %, at least about 97 vol %, at least about 98 vol %, at least about 99 vol %, at least about 99.1 vol %, at least about 99.2 vol %, at least about 99.3 vol %, at least about 99.4 vol %, at least about 99.5 vol %, at least about 99.6 vol %, at least about 99.7 vol %, at least about 99.8 vol %, at least about 99.9 vol %, at least about 99.99 vol %, or at least about 99.999 vol % CO₂.

At step 407, the decomposed carbonated medium, or carbonation medium, is removed from the reaction vessel. Removal of the carbonation medium may be facilitated by the facilitation device and rotation of the reaction vessel. In some implementations, such as when the reaction vessel is oriented vertically, removal of the carbonation medium is facilitated by gravity.

### Example 1—Furnace

Embodiments described herein can give way to calcination of carbonated medium that uses renewable energy and is more cost efficient than traditional methods of calcination. An example high-temperature decomposition reactor includes a reaction vessel having an internal diameter of about two meters with a reactor wall thickness of about 0.1 to about 0.2 m. Disposed around the reaction vessel is a furnace having an outer diameter of about 6.2 meters. Accordingly, the furnace thickness is approximately 2.1 meters.

The example high-temperature decomposition reactor requires approximately 1,700 kilowatt hours (“kWh”) of energy to decompose enough carbonated medium to capture one tonne of carbon dioxide (tCO₂). The furnace is composed of a furnace material having an energy storage density of approximately 100 kilowatt hours per cubic meter (kWh/m³) and a production utilization of 50%. In other words, the furnace is able to be utilized 50% of the time.

The furnace diameter of 6.2 m offsets the energy requirements for the high-temperature decomposition reactor during 50% of the operation time. If the cost of electricity during this time is $0.06/kWh compared to $0.03/kWh during the day, this would result in a 25% decrease in the operating costs of the system. At scale, operating costs dominate the overall costs of the system and energy dominates the operating costs.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A reactor, comprising:
a reaction vessel defining an inner volume configured to contain a quantity of carbonated medium while the quantity of carbonated medium transitions to a quantity of carbonation medium;
a furnace disposed around the reaction vessel, the furnace including a furnace material configured to absorb and/or transmit heat; and
an insulation layer disposed around the furnace and configured to reduce thermal losses from the reactor.

2. The reactor of claim 1, wherein the reaction vessel comprises a conductive metal.

3. The reactor of claim 1, wherein the reaction vessel comprises a thermal storage material.

4. The reactor of claim 1, wherein the furnace includes at least one of graphite, granite, basalt, quartzite.

5. The reactor of claim 1, wherein the furnace includes a chamber configured to contain a flow of molten salt.

6. The reactor of claim 1, wherein the insulation layer includes at least one of periclase, a silica based refractory material, an alumina-based refractory material, fiberglass, mineral wool, cellulose, natural fibers, cementitious foam, polyurethane, perlite, polystyrene, or polyisocyanurate.

7. The reactor of claim 1, further comprising:
a rotation mechanism configured to impart rotational motion of-to the reaction vessel.

8. The reactor of claim 1, wherein the furnace material is configured to simultaneously absorb and transmit heat.

9. The reactor of claim 5, wherein the molten salt includes at least one of sodium nitrate, lithium nitrate, potassium nitrate, sodium chloride, or N-ethylpyridinium.

10. The reactor of claim 7, further comprising:
a facilitation device disposed in the reaction vessel, the facilitation device configured to move the carbonated medium from a first position to a second position within the reactor vessel when the rotation mechanism imparts rotational motion to the reactor vessel.

11. The reactor of claim 9, wherein the second position is at a lower potential energy state than the first position.

12. A method, comprising:
feeding a carbonated medium into an inner volume of a reaction vessel;
heating a furnace material, the furnace material contacting and at least partially surrounding the reaction vessel;
transferring heat from the furnace material to the inner volume of the reaction vessel such that the carbonated medium is separated into a carbonation medium and carbon dioxide;
removing the carbon dioxide from the reaction vessel; and
removing the carbonation medium from the reaction vessel.

13. The method of claim 12, wherein heating the furnace material includes providing heat to the furnace material from a renewable electricity source, the renewable electricity source including at least one of solar power, wind power, or geothermal power.

14. The method of claim 12, wherein the furnace material includes at least one of graphite, granite, basalt, quartzite.

15. The method of claim 12, wherein the furnace material includes a molten salt.

16. The method of claim 15, wherein the molten salt including at least one sodium nitrate, lithium nitrate, potassium nitrate, sodium chloride, or N-ethylpyridinium.

17. The method of claim 12, further comprising:
rotating the reaction vessel to facilitate the movement of the carbonated medium through the reaction vessel from a first end of the reactor vessel to a second end of the reactor vessel.

18. The method of claim 17, wherein the first end of the reactor vessel is at a lower potential energy state than the second end of the reactor vessel.

19. The method of claim 12, further comprising:
purifying the carbon dioxide.

20. The method of claim 12, wherein the reactor vessel comprises a conductive material.
